(19) United States
(12) Patent Application Publication
(10) Pub. No.: US 2026/0311070 A1
(43) Pub. Date: Oct. 8, 2026

(54) RESERVATION MANAGEMENT USING DISTRIBUTED COMPUTING NETWORKS

(71) Applicant: OwnersTable, Inc., Austin, TX (US)

(72) Inventor: Duane Tharp, Austin, TX (US)

(73) Assignee: OwnersTable, Inc., Austin, TX (US)

(21) Appl. No.: 19/098,037

(22) Filed: Apr. 2, 2025

(51) Int. Cl. G06Q 10/02; G06F 16/334

(52) U.S. Cl. CPC G06Q 10/02; G06F 16/334

(57) ABSTRACT

Techniques for reservation management using distributed computing networks are described, including receiving a request at a platform, the request initiated at a client in data communication with the platform, parsing the request to perform a query of a database in data communication with the platform, generating an augmented request with responsive data retrieved from the database in response to the query, inserting a reservation identifier into the augmented request, the augmented request including the reservation identifier, a first platform-generated attribute, and a second platform-generated attribute, transmitting the augmented request to another client, and using the augmented request, the first platform-generated attribute, and the second-platform generated attribute to update the another client.

### FIELD

The present invention relates generally to software. More specifically, reservation management using distributed computing networks is described.

### BACKGROUND

Managing and allocating resources, whether physical or intangible, is an efficiency challenge that is persistent, regardless of technological change and improvement. Achieving 100% efficient allocation of resources is a quintessential goal for individuals, companies, organizations, and entities alike, but is generally difficult to attain due to many factors that can create inefficiencies.

In allocating electronic or digital resources, such as allocating availability or recycling or reintroducing availability into online systems, reservation management becomes a substantial challenge and one that requires solutions beyond those provided by conventional systems. For example, a system that utilizes reservations to hold a future place, time, or resource for a given use, are often inefficient because conventional solutions are limited in design and encounter performance limitations during execution/runtime caused by reservation changes, cancellations, or other operations. Unfortunately, conventional systems often cannot fully address changes, modifications, or deletions due to many factors ranging from cancellations, limited redistribution of cancelled reservations, lack of incentives to resell cancelled reservation inventory, or other problems that prohibit, discourage, or altogether prevent reservations from being reset, recycled, or restored to availability status.

In conventional application such as reservations management (e.g., dining establishments, restaurants, airborne or waterborne carriage, cargo and freight forwarding, handling, carriage, and transportation, vehicle and vessel rental, medical/dental appointments, or other goods, services, or resource reservations systems), the management and handling of reservations is fraught with difficulties and problems, particularly with regard to avoiding waste, inefficient allocation, or lack of functionality that permits increased rebooking of cancelled reservations. Some conventional solutions are not configured or are incapable of performing data functions that permit, for example, recycling or reuse of cancelled reservations, resulting in loss of revenue that is typically expensive, inefficient, and difficult to avoid. Other conventional solutions fail to realize value in cancelled or modified reservations, particularly in settings and situations where time reservations are critical to the operational income generation of an enterprise or organization such as a restaurant that receives cancellations on short notice often with very little time available to recycle or publish reservation availability.

Conventional solutions focused on solving problems of resource allocation and managing reservations are typically inefficient and expensive. Rather than focus on the more difficult task of improving algorithmic and intelligence-based computing processes (distributed or local) that function to make reservation rebookings efficient in time, cost, and accuracy, conventional solutions typically tend to be problematically additive, particularly in adding increased costs, premiums, or expense, particularly as it relates to requiring employees, contractors, or other staff to publish, promote, and rebook cancelled reservation inventory. In fact, conventional solutions can also be limited due to little or no algorithmic or programmatic functionality that can help prioritize, weight, and/or rank reservations intended for rebooking. These problems represent substantial costs to consumers and businesses alike and, ultimately, slow or altogether discourage innovation in numerous industries challenged with matching supply (i.e., reservation inventory) to demand (e.g., user demand for popular venues, services, or goods) accurately, rapidly, and efficiently. Costs in conventional solutions take numerous forms and formats and can include price, time spent on reserving a resource, reserving a greater or lesser amount of a resource (thus imposing costs and inefficiencies that can lead to waste, overutilization, or incapacity due to under-resourcing), and consumption of existing resources to reserve a resource that is valued less.

A typical conventional solution field is online reservation platforms for restaurants, hotels, or travel/transportation/carriage, which often impose advance fees, premiums, or deposits as an increased revenue source for inbound reservation requests for resources. Not only do these penalties dilute or weaken demand for a given type of reservation, but these also impose additional and significant costs. In many conventional solutions, cancellation or reallocation of reservation requests can also lead to unused or unallocated reservation inventory that ultimately goes unsold and results in expensive loss to a restaurant. Conventional solutions such as online reservation systems automatically return cancelled reservations to accessible online inventory, but fail to perform further processing to generate opportunities for reselling, re-reserving, or otherwise performing other actions that may result in the cancelled reservation being filled again, possibly at a higher price because of demand. When a reservation is cancelled using a conventional online reservation platform, availability for the same time period and party size is made available for reserving again, but with little else added to encourage (often last minute), promote, or resell a newly available reservation time (for a given party size), thus losing opportunities that can result in the generation of substantial revenue. As another example of problems with conventional solutions, unused or unsold reservations at popular dining establishments using conventional reservation systems often are unable to reallocate cancelled reservation, particularly those made with short notice before the start time of a given reservation. This incapacity thus leads to unused/unsold reservation inventory that, in the course of a single evening, could result in the loss of thousands of dollars in revenue. Similar inefficiencies in the reservation of resources (e.g., time, goods, and services) can be found in almost every commercial and industrial sector suggesting there is a widespread need for a solution.

Thus, what is needed is efficient reservation management without the limitations of conventional techniques.

### BRIEF DESCRIPTION OF THE DRAWINGS

Various embodiments of the invention are disclosed in the following detailed description and the accompanying drawings:

FIG. 1 illustrates an exemplary data topology for reservation management using distributed computing networks;

FIG. 2 illustrates an exemplary system for reservation management using distributed computing networks;

FIG. 3 illustrates an exemplary application architecture for reservation management using distributed computing networks;

FIG. 4A illustrates an exemplary user interface for reservation management using distributed computing networks;

FIG. 4B illustrates an exemplary user interface for reservation management using distributed computing networks;

FIG. 5 illustrates an exemplary data flow diagram for reservation management using distributed computing networks;

FIG. 6 illustrates an exemplary augmented request used in reservation management using distributed computing networks;

FIG. 7A illustrates an exemplary process for reservation management using distributed computing networks;

FIG. 7B illustrates an exemplary process for generating an augmented request using techniques for reservation management using distributed computing networks;

FIG. 7C illustrates an exemplary process for using an augmented request in reservation management using distributed computing networks;

FIG. 7D illustrates an exemplary process for augmented request handling in reservation management using distributed computing networks;

FIG. 7E illustrates an exemplary process for handling a cancellation request in reservation management using distributed computing networks;

FIG. 8 illustrates an alternative exemplary process for reservation management using distributed computing networks; and

FIG. 9 illustrates an exemplary computer system suitable for reservation management using distributed computing networks.

### DETAILED DESCRIPTION

Various embodiments or examples may be implemented in numerous ways, including as a system, a process, an apparatus, a user interface, or a series of program code or instructions on a computer readable medium such as a storage medium or a computer network including program instructions that are sent over optical, electronic, electrical, chemical, wired, or wireless communication links. In general, individual operations or sub-operations of disclosed processes may be performed in an arbitrary order, unless otherwise provided in the claims.

A detailed description of one or more examples is provided below along with accompanying figures. This detailed description is provided in connection with various examples, but is not limited to any particular example. The scope is limited only by the claims and numerous alternatives, modifications, and equivalents. Numerous specific details are set forth in the following description in order to provide a thorough understanding. These details are provided for the purpose of illustrating various examples and the described techniques may be practiced according to the claims without some or all of these specific details. For clarity, technical material that is known in the technical fields and related to the examples has not been described in detail to avoid unnecessarily obscuring the description or providing unnecessary details that may be already known to those of ordinary skill in the art.

As used herein, “system” may refer to or include the description of a computer, network, or distributed computing system, topology, or architecture using various computing resources that are configured to provide computing features, functions, processes, elements, components, or parts, without any particular limitation as to the type, make, manufacturer, developer, provider, configuration, programming or formatting language (e.g., Python™, R, JAVA®, JAVASCRIPT®, XML, HTML, and others, without limitation or restriction), service, class, resource, specification, protocol, or other computing or network attributes. As used herein, “software” or “application” may also be used interchangeably or synonymously with, or refer to a computer program, software, program, firmware, or any other term that may be used to describe, reference, or refer to a logical set of instructions that, when executed, performs a function or set of functions within a computing system or machine, regardless of whether physical, logical, or virtual and without restriction or limitation to any particular implementation, design, configuration, instance, or state. Further, “platform” may refer to any type of computer hardware (hereafter “hardware”) and/or software using, hosted on, served from, or otherwise implemented on one or more local, remote, and/or distributed data networks such as the Internet, one or more computing clouds (hereafter “cloud”), or others. Data networks (including computing clouds) may be implemented using various types of standalone, aggregated, or logically-grouped computing resources (e.g., computers, clients, servers, tablets, notebooks, smart phones, cell phones, mobile computing platforms or tablets, and the like) to provide a hosted environment for an application, software platform, operating system, software-as-a-service (i.e., “SaaS”), platform-as-a-service, hosted, or other computing/programming/formatting environments, such as those described herein, without restriction or limitation to any particular implementation, design, configuration, instance, version, build, or state. Distributed resources such as cloud computing networks (also referred to interchangeably as “computing clouds,” “storage clouds,” “cloud networks,” or, simply, “clouds,” without restriction or limitation to any particular implementation, design, configuration, instance, version, build, or state) may be used for processing and/or storage of varying quantities, types, structures, and formats of data, without restriction or limitation to any particular implementation, design, or configuration. In the drawings provided herewith, the relative sizes and shapes do not convey any limitations, restrictions, requirements, or dimensional constraints unless otherwise specified in the description and are provided for purposes of illustration only to display processes, data, data flow chart, application or program architecture or other symbols, as described in this specification.

As described herein, structured and unstructured data may be stored in various types of data structures including, but not limited to databases, repositories, warehouses, datalakes, lakehouses, data stores, and other data structures and facilities configured to manage, store, retrieve, process calls for/to, copy, modify, or delete data or sets of data (i.e., “datasets”) in various computer programming languages and formats (e.g., structured, unstructured, binary, and others) in accordance with various types of structured and unstructured database schemas and languages such as SQL®, MySQL®, NoSQL™, DynamoDB™, R, or others, such as those developed by proprietary and open source providers like Amazon® Web Services, Inc. of Seattle, Washington, Microsoft®, Oracle®, Google®, Salesforce. com, Inc., and others, without limitation or restriction to any particular schema, instance, or implementation. Further, references to databases, data structures, or any type of data storage facility may include any embodiment as a local, remote, distributed, networked, cloud-based, or combined implementation thereof, without limitation or restriction. In some examples, data may be formatted and transmitted (i.e., transferred over one or more data communication protocols) between computing resources using various types of wired and wireless data communication and transfer protocols such as Hypertext Transfer Protocol (HTTP), Transmission Control Protocol (TCP)/ Internet Protocol (IP), Internet Relay Chat (IRC), SMS, text messaging, instant messaging (IM), WiFi, WiMax, or others, without limitation. Further, as described herein, disclosed processes implemented as software may be programmed using JAVA®, JAVASCRIPT®, Python, R, Scala, Perl, XML, HTML, or other data formats and programming languages, without limitation. As used herein, references to layers of an application architecture (e.g., application layer or data layer) may refer to a stacked layer application architecture designed and configured using models such as the Open Systems Interconnect (OSI) model or others.

The described techniques may be implemented as a software-based application, platform, or system. In some examples, machine learning, deep learning, neural network, and other types of computing, processing, and analytical algorithms such as those used in various computer science-related fields may be used to implement techniques related to “artificial intelligence” (i.e., “AI”), generative pre-trained transformers (i.e., “GPT”), transformers, generative artificial intelligence (e.g., such as “chatbots,” inference models, and other types of platforms such as those developed by OpenAI™, Microsoft®, xAI™, Google® (e.g., Gemini™, Bard™), Anthropic™, DeepSeek, Stability AI (e.g., Stability Diffusion), MidJourney, and others, without limitation or restriction) including, but not limited to, any type of large language model (hereafter “LLM”), and/or transformer. While there is no particular dependency to a given type of model (e.g., large language model) or algorithm (e.g., machine learning, deep learning, neural networks, intelligent agents, or any other type of algorithm that, through the use of computing machines, attempts to simulate or mimic certain attributes of natural intelligence such as cognitive problem solving, without limitation or restriction), there is likewise no requirement that only a single instance or type of a given algorithm or dataset be used in the implementations described. Algorithms may be untrained or trained using model data, external data, internal data, or other public or private sources of data that may be used to improve the accuracy of calculations performed or trained to generate output data for use in applications, systems, or platforms in data communication with software module or engine-based implementations. The techniques described herein are not limited to any specific implementation, design, function, operation, structure, configuration, specification, or other characteristics or attributes and may be varied without limitation or restriction. The size, shape, quantity, configuration, function, or structure of the elements shown in the various drawings may be varied and are not limited to any specific implementations shown. Drawings accompanying this Specification are provided for exemplary purposes of illustration and are not intended to be limiting.

Various embodiments or examples may be implemented in numerous ways, including as a system, a process, an apparatus, a user interface, or a series of program instructions on a computer readable medium such as a computer readable storage medium or a computer network where the program instructions are sent over optical, electronic, or wireless communication links. In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description.

In some examples, the described techniques may be implemented as a computer program or application (“application”) or as a plug-in, module, or sub-component of another application. The described techniques may be implemented as software, hardware, firmware, circuitry, or a combination thereof. If implemented as software, the described techniques may be implemented using various types of programming, development, scripting, or formatting languages, frameworks, syntax, applications, protocols, objects, or techniques, including C, Objective C, C++, C #, Adobe® Integrated Runtime™ (Adobe® AIR™), ActionScript™, Flex™, Lingo™, Java™, Javascript™, Ajax, Perl, COBOL, Fortran, ADA, XML, MXML, HTML, DHTML, XHTML, HTTP, XMPP, and others. Design, publishing, and other types of applications such as Dreamweaver®, Shockwave®, Flash®, and Fireworks® may also be used to implement the described techniques. The described techniques may be varied and are not limited to the examples or descriptions provided.

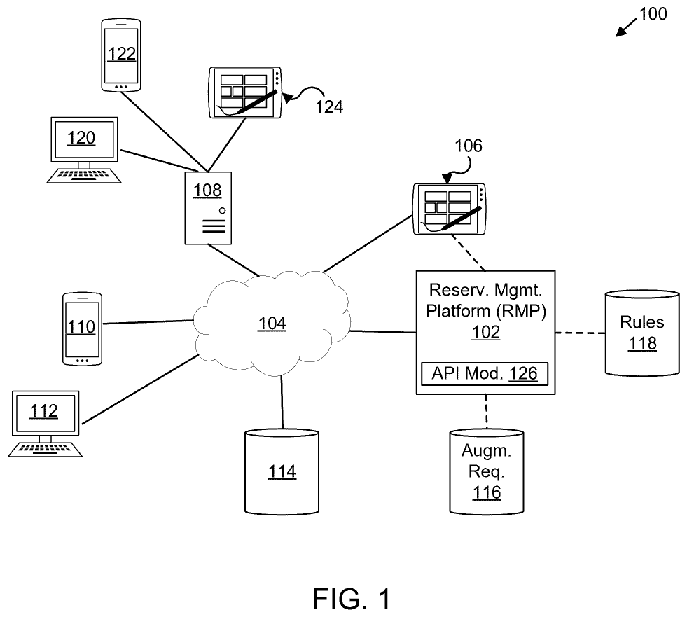

FIG. 1 illustrates an exemplary data topology for reservation management using distributed computing networks. Here, topology 100 includes reservation management platform (hereafter “RMP”) 102, network 104, computing tablet (hereafter “tablet”) 106, computing server, remote, virtual, or physical (hereafter “server”) 108, mobile computing device (hereafter “mobile device”) 110, computer (e.g., laptop, desktop, computing device 112, data repository 116, augmented request data repository 116, rules data repository 118, computing device 120, mobile device 122, computing tablet (hereafter “tablet”) 124, and application programming interface module (hereafter “API module”) 126. In some examples, topology 100 may be illustrative of an exemplary computing environment in which the described inventive techniques are configured to run or execute. As shown, RMP 102 may be configured to transfer and receive data from one or more of tablet 106, server 108, mobile device 110, computing device 112, data repository 116, augmented request data repository 116, rules data repository 118, computing device 120, mobile device 122, tablet 124, and/or API module. 126.

In some examples, a data request may be transferred from one or more of tablet 106, mobile device 110, computing device 112, computing device 120, mobile device 122, tablet 124 (collectively “clients”) or server 108 over an API to RMP 102 using, for example, API module 126. As an example, a reservation request for a given service or resource (e.g., hotel, transportation, restaurant reservation, or the like) may be generated as a data request (hereafter “request”) from one or more of clients 106, 110-112, or 120-124 to RMP 102 over network 104. Once received, RMP 102 may perform various data operations according to one or more rules retrieved (in response to a query) from rules data repository 118. In some examples, the output of data operations performed by RMP 102 may generate an “augmented request” (i.e., a data request that has been augmented or modified in accordance with logic executed by RMP or, data accessed from rules 118 or other data repositories (e.g., data repository 114) and, once generated, stored in augmented request data repository 116.

As an example, a request to reserve a time and party size at a given restaurant may be initiated from mobile device 122 and sent via server 108 over network 104 to API module 126 and RMP 102. Once received, RMP 102 may be configured to parse a received request to make a reservation and, from the parsing, identify one or more attributes, metadata, or other data that may be used to query rules data repository 118 to invoke one or more data operations or processes to perform. In other examples, attributes may be used to determine how to apply rules queried/retrieved from rules data repository 118 during the generation of an augmented request (as described in greater detail below). In further examples, attributes may also be parsed from a received request and used to identify rules to query/retrieve from rules data repository 118. Further, attributes may be used at any point throughout the parsing of a received request and during processing of parsed data from a received request to generate an augmented request. As used herein, a request may be any type, form, format, or structure of data that is transmitted from a RMP client (as described in greater detail herein) to RMP 102 and used to generate an augmented request, a copy or cached version of which may be stored in augmented request data 116.

After performing data operations (e.g., parsing a received request to identify a given user or profile and referencing a data repository (e.g., data repository 114), an augmented request may be generated. Once generated, an augmented request may be transmitted from RMP 102 over network 104 to a destination (e.g., tablet 106, which may be a computing device used at the requested restaurant and used to open and access requests as well as transfer data with one or more other software or SaaS platforms used for local/site reservation management, which may be accessible by various persons serving different roles (e.g., employees, contractors, owners, or others serving in roles such as, in the contextual example of a restaurant or dining establishment, host/hostess, server(s), maître d'hotel, sommelier, executive chef, sous chef, pastry chef, and others, without limitation or restriction). In some examples, an augmented request may include information related to a given restaurant, user/diner, and include various types of information and data that may include attributes directed to preferences (e.g., time, seating, personal, culinary, cuisine, or the like, without limitation or restriction), history, spending habits (e.g., Per-Person-Average expenditures per dining visit), and other attributes, parameters, preferences, characteristics, or the like, without limitation or restriction.

In other examples, a request may also include data directed from a client (e.g., clients 106, 110-112, 120-124) that indicates a change or cancellation of a reservation. For example, a request may be transmitted over network 104 to RMP 102 indicating a time, quantity, or other change to be made to a previously-transmitted reservation. Upon parsing and analysis by RMP 102, a change may be made accordingly, querying rules data repository 118 to identify any rules or business rules (i.e., any type of business, system, or user-specified rule, including any manually, automatically, or semi-automatically-created, including those generated using any type of AI-related technologies, such as those described above) to be applied to a received request.

As a further example of RMP 102 capabilities, a request may be transmitted to and received by RMP 102 that indicates cancellation of a previous reservation (i.e., request). Upon receipt of a request to cancel a reservation by RMP 102 using API Module 126, processing may be performed on the cancellation request, querying and retrieving rules from rules data repository 118 to generate an augmented request that may be stored (and later retrieved, queried, or otherwise used) in augmented request data repository 116. In some examples, a cancellation request received by RMP 102 may be used to generate an augmented request (not shown) that may be stored in augmented request data repository 116 and/or transmitted to one or more clients (e.g., clients 106, 110-112, or 120-124, or the like) over network 104. Further, an augmented request generated from a cancellation request may be published, distributed, or otherwise displayed at one or more of clients 106, 110-112, or 120-124 on a marketplace (not shown).

Here, a marketplace (not shown) may include an open marketplace instantiated, hosted, and/or served by RMP 102. An open marketplace may be a hosted or SaaS-based service accessible by one or more of clients 106, 110-112, or 120-124 in order to view details and interact with an augmented request generated from a cancellation request sent to RMP 102. An augmented request generated, for example, using business rules queried and retrieved from rules data repository 118, may include various types of information and data, including, in the example of a restaurant, time, party size, seating and other preferences. In still other examples, an augmented request published by RMP 102 to a marketplace may also include information that may be useful to an organization when determining whether to accept a modified reservation request or to bid on an augmented request generated from a cancellation request. As discussed in greater detail below, an augmented request may also be generated to include a bid, price, or other information that may be used to enable an organization in data communication with RMP 102 (e.g., one or more of clients 106, 110-112, 120-124, or others (not shown), without limitation or restriction to the examples, shown and described) to purchase or engage in a transaction to accept an offered reservation identified by data in the augmented request. In other examples, an augmented request generated from a cancellation request may also be published, distributed, or otherwise displayed on a closed marketplace, which may be a program, application, or platform used by a given organization, but without data connectivity with other programs, applications, or platforms.

In some examples, a closed marketplace may be a program, application, or platform that is used by an organization to rebook, cancel, or schedule a reservation, but without data communication or interactive capability with another program, application, or platform to perform similar purposes. Here, RMP 102 may be configured to serve, host, and/or instantiate an open marketplace that permits other programs, applications, and/or platforms to purchase, bid upon, or otherwise accept (or reject) a reservation identified in an augmented request generated from a cancellation request. As an example, an augmented request may be published, distributed, or otherwise displayed on an electronic commerce website (hereafter “website” and “site” may be used interchangeably), auction site, search engine, or other online site or property used to promote commercial transactions such as bidding on or making/purchasing reservations represented by data in an augmented request generated from a cancellation request received, parsed, and processed by RMP 102. The manner in which a reservation “ticket” is generated and represented by an augmented request may be varied and is not limited to a specific form or format. For example, a ticket associated with a reservation identified by data included in an augmented request generated by RMP 102 from a received cancellation request (i.e., from one or more of clients 106, 110-112, 120-124, or others (not shown), without limitation or restriction) may include various types of data, information, metadata, characteristics, or attributes (hereafter “attributes” or “data attributes,” which may be used interchangeably without limitation or restriction) such as price, per person average (hereafter “PPA” for a given ticket), reservation site (e.g., restaurant, hotel, airline, cruise line, resort, and the like, without limitation or restriction), and others, without limitation or restriction. Regardless, RMP 102 may be configured to generate and transmit augmented requests received directly or indirectly from one or more of clients 106, 110-112, 120-124, or others (not shown), without limitation or restriction.

For example, an augmented request generated from a cancellation request sent to or otherwise intercepted by RMP 102. In some examples, a request may be sent from one or more of clients 106, 110-112, 120-124, or others (not shown) to server 108 (or another device) over data network 104 and RMP 102 may be configured to monitor data traffic for the intended client and, upon detection of data that flags or identifies a request, RMP 102 may be called and receive a copy of said request. In other examples, arrangement, size, position, quantity, function, structure, process, and/or configuration of the above-described elements may be varied and are not limited merely to or by any specific description or feature shown or described in this Detailed Description.

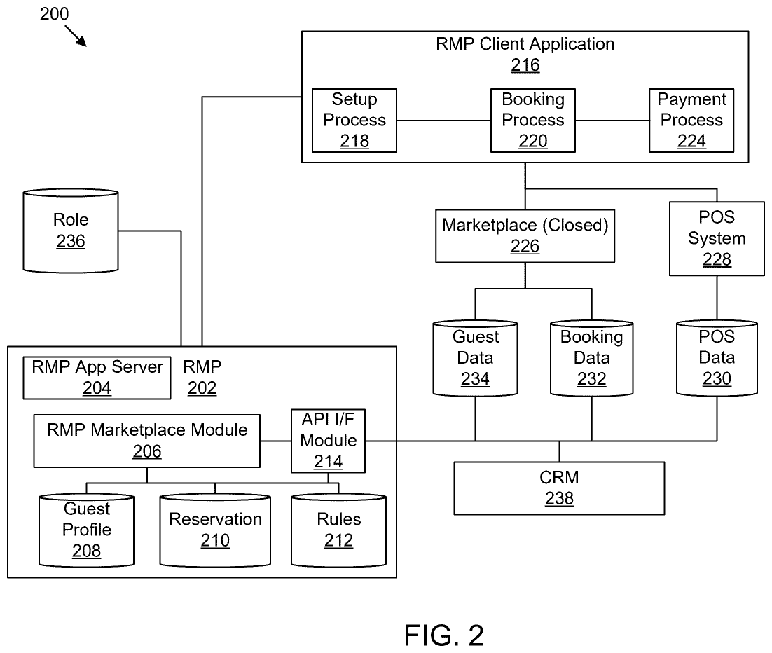

FIG. 2 illustrates an exemplary system for reservation management using distributed computing networks. Here, system 200 includes RMP 202, RMP app server 204, RMP marketplace module 206, guest profile data 208, reservation data 210, rules data 212, API Interface (hereafter “I/F”) module 214, RMP client application 216, setup process 218, booking process 220, payment process 224, marketplace (closed) 226, point of sale (hereafter “POS”) system 228, POS data 230, booking data 232, guest data 234, role data 236, and CRM 238. In some examples, system 200 may be used to implement a reservation management platform such as that shown in which RMP 202 and RMP client application 216 are hosted and served from a local, remote, distributed, physical, logical, or virtual computing configuration. No particular configuration of servers, computers, or computing devices is required to implement system 200 and the elements shown.

Here, RMP 202 is in data communication with RMP client application 216 and other systems, applications, platforms, and repositories such as marketplace (closed) 226, POS system 228, POS data 230, booking data 232, guest data 234, role data 236, and CRM 238. As used herein, POS data 230, booking data 232, guest data 234, and role data 236 may be data repositories implemented and configured using any type of data storage facility, configuration, or structure, some of which are described herein, without limitation or restriction to any particular instance, implementation, configuration, type, or structure (e.g., database, data facility, data warehouse, data lake, or others). Also, marketplace (closed) 226, POS system 228, and CRM 238 may be any type of program, application, or platform used to make, modify, or cancel a reservation (i.e., as represented by marketplace (closed)), provide point-of-sale features and functionality such as transactions, purchases, and refunds (i.e., as represented by POS system 228), and implemented customer relationship management services, features and functionality (i.e., as represented by CRM 238). As shown, role data 236 may include any type, form, format, or content of data associated with the various roles of an organization, whether employees, contractors, owners, shareholders, founders, or others, without limitation or restriction.

Here, RMP 202 may be configured to transfer and process data (e.g., requests, augmented requests, as described herein) with RMP client application 216. In some examples, RMP client application 216 may be installed, hosted, or otherwise executed as a program or application on a client device (e.g., clients 106, 110-112, 120-124 (FIG. 1), or others, without limitation or restriction) used by an organization that utilizes RMP 202 to manage, make, cancel, purchase, sell, auction, or perform other functions with regard to the processing of requests (e.g., generating augmented requests that are sent to and used to post reservations for sale or purchase by marketplace module 206 (i.e., an open marketplace) or marketplace (closed) 226 (i.e., a marketplace used by an organization as a dedicated forum, channel, network, or online venue for offering tickets generated and identified in an augmented request generated from a cancellation request). As an example, RMP client application 216, in the context and setting of a restaurant, may be used on a client (e.g., clients 106, 110-112, 120-124 (FIG. 1)) by staff members (e.g., host/hostess, maître d'hotel, manager, owner, and others, without limitation or restriction) to manage reservations for a given night. Here, RMP client application 216 may be configured to perform setup process 218 to integrate RMP 202 data for use by an organization while also using marketplace (closed) 226. In some examples, setup process 218 may be performed, run, or executed to install RMP client application 216 for use on a given device (e.g., clients 106, 110-112, 120-124 (FIG. 1)) or by a given organization. As another example, booking process 220 may be invoked by RMP client application 216 to “book” or enter a request (i.e., reservation, cancellation, modification, or the like) for a given organization and data generated from a “booking” may be stored in booking data 232 for use by RMP client application 216 and marketplace (closed) 226. In some examples, marketplace (closed) 226 may be implemented using platforms such as those developed by Resy Networks, Inc., OpenTable, Inc., KAYAK Software Corporation, Tock, LLC, SevenRooms Inc., Elomi Corporation (dba Dorsia), among others, without limitation or restriction. However, marketplace (closed) 226 may be closed reservation platforms that, unlike RMP 202, are not configured for data communication or networked communication with any other platforms, applications, or services. Here, RMP 202, using RMP client application 216, may be configured for data communication with multiple marketplaces (closed) and marketplace (closed) 226 is but a singular example. In other examples, many types, quantities, and configurations of platforms with various features and functionality may be used to implement marketplace (closed) 226, but placed in data communication with RMP 202.

Referring back to RMP client application 216, payment process 224 may be called, invoked, or otherwise executed to perform various types of payment functions, without limitation or restriction. Data generated or used by payment process 224 may be further processed by third party payment platforms such as POS system 228, storing payment data in POS 230. Payment data 230, in some examples, may be accessed by an organization using a closed marketplace (used herein interchangeably with “marketplace (closed)”) to provide reservation management software locally to an organization; however, marketplace (closed) 226 is limited in features and functionality to making, cancelling, or modifying reservations and/or managing an availability schedule. Here, RMP 202 implements other features and functionality beyond merely making, modifying, or cancelling reservations. For example, RMP 202 may be used to convert a cancellation request into a ticket, as described herein. In some examples, RMP 202 may be implemented using software, computer programming languages, and/or data schemas (such as those described above) to implement an intermediate layer of rules-based routing using configurable rules that, in some examples, may be created and configured manually, automatically, or semi-automatically and used to determine a software, data, and/or signal path for routing data associated with a cancelled reservation (i.e., request). Further, by routing requests (e.g., cancellation requests) through a configurable layer of rules-based processing before “returning” the cancelled reservation to reservation inventory (i.e., reopening a previously reserved window of availability), by applying rules to determine paths for routing data associated with a cancelled reservation (e.g., cancellation request), computational overhead may be reduced, network resource utilization may be increased, and latency in searching for, identifying, and retrieving reservation availability may be decreased. The techniques described herein may be used to ultimately increase reservation system performance by processing reservation requests to make available and utilize reservation inventory efficiently.

Referring to CRM 238, some organization may implemented software-based services or access SaaS (i.e., “cloud”)-based services to implement customer relationship management applications, features, or functionality. Using programs, applications, or platforms from companies such as Microsoft Corporation, Salesforce, Inc., and others, CRM 238 may be implemented to transfer data between marketplace (closed) 226 and RMP 202, including role data 236. Here, role data 236 may be data related to employees, contractors, owners, and other stakeholders associated with an organization using RMP 202 to manage reservations in accordance with the inventive techniques described herein, including receiving, parsing, and processing a request to cancel a reservation into a ticket, the latter of which may be published, distributed, or displayed for purchase by RMP 202 on a marketplace enabled by RMP marketplace module 206 and/or marketplace (closed) 226. Role data 236, in other examples, may also be used to determine what information to include in a ticket when generated from an augmented request. For example, RMP 202 may identify RMP client application 216 as being a computing tablet, tablet, laptop, desktop, or other type of computing device being used by a restaurant to manage reservations. RMP client application 216 may be installed and used to review “booking” or “tickets” that are available for acceptance by a restaurant, but include valuable information such as an estimated revenue amount from a given diner, individual preferences or tastes of a given diner (i.e., purchaser of a ticket generated from an augmented requested), or other valuable information beyond party size, time, and expected duration of the ticketed dining session. In so doing, a cancelled reservation may be resold, advertised, published, or otherwise distributed actively and widely beyond merely making available a previous reservation. In other words, a cancelled reservation can become a mechanism or construct used to not only rebook a reservation (i.e., purchase a ticket), but also provide valuable information regarding a given purchaser of a ticket generated from an augmented request (not shown) produced by RMP 202 using data from one or more of guest profile data 208, reservation data 210, and/or rules data 212. Further, data associated with an augmented request (not shown) to generate a ticket that is distributed on marketplaces (i.e., marketplaces for bids, tickets, reservations, or the like from RMP marketplace module 206 and/or marketplace (closed) 226) may also be used to convey information to encourage (i.e., incent) an organization to accept a ticket generated from a cancelled reservation. Examples of information may include guest profile data of a user that has purchased a ticket, including PPA, preferences, guest profile historical data, and other information that could assign other value associated with a ticket that may encourage or create opportunities to add a premium and/or gratuity amount to a ticket price to an organization. In other words, valuation of a ticket may be determined by RMP application server (hereafter “RMP app server”) 204 to include additional amounts to encourage an organization such as a restaurant to accept a ticket. Such additional amounts may go beyond merely the estimated cost resulting from a reservation. A ticket purchaser (i.e., guest, user, traveler, diner, or others) may be valued at a price by an organization to include a premium for accepting, for example, a last minute dining reservation at an exclusive restaurant, as well as an advance gratuity amount such that, when an organization is using RMP client application 216 to review, accept, and/or deny a “booking” or ticket (hereafter “booking” and “ticket” may be used interchangeably, in some examples) the value may be manually accepted. In other examples, a booking or ticket may also be semi-automatically or automatically accepted if certain rules, business rules, conditions, terms, or other parameters (e.g., rules stored in rules data repository 212) are met. In other examples, arrangement, size, position, quantity, function, structure, process, and/or configuration of the elements shown may be varied and are not limited merely to or by any specific description or feature shown or described in this Detailed Description.

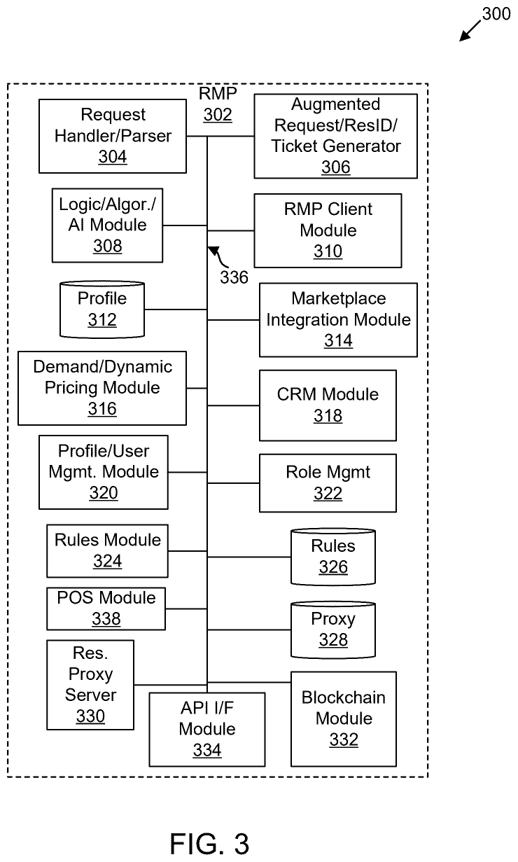

FIG. 3 illustrates an exemplary application architecture for reservation management using distributed computing networks. Here, exemplary application architecture 300 (hereafter “architecture 300”) includes RMP 302, request handler/parser 304, augmented request/reservation ID/ticket generator 306 (hereafter “augmented request generator 306), logic/algorithmic/AI module 308, RMP client module 310, profile data 312, marketplace integration module 314, demand dynamic pricing module 316, CRM module 318, profile user management module 320, role management 322, rules module 324, rules data 326, proxy data 328, reservation proxy server 330, blockchain module 332, application programming interface/interface (hereafter “API I/F”) module 334, data bus 336, and point-of-sale module 338 (hereafter “POS module 338”). As represented by the outline of the broken line, RMP 302 and elements 304-334 may be implemented on a standalone server or other computing device, but also remotely or in a distributed basis using one or more physical, virtual, or logical machines instanced across various types of data networks using one or more data types, data forms/formats, and data protocols (e.g., transmission, control, and others, without limitation or restriction). For example, using web services offerings from companies such as Amazon, Inc. of Seattle, Washington, Azure from Microsoft Corporation of Redmond, Washington, Apple Computer of Cupertino, California, and others, RMP 302 may be implemented to provide various features and functionality such as those described herein.

As shown, elements 304-334 and 338 of RMP 302 may be configured in data communication and transfer data and signals between elements 304-334 and 338 using data bus 336. Here, RMP 302 may include request handler/parser 304, which may be configured to receive, intercept, and/or parse requests sent to or intercepted by RMP 302. As an example, when a request for a reservation is sent to an organization using a networked Reservation Management Platform such as RMP 302, a copy of the request may be generated and sent to RMP to be received over API I/F module 334 and initially processed by request handler/parser 304. Parsing a received request, request handler/parser 304 may transmit data and/or signals to logic/algorithmic/AI module 308 to identify and determine the type of request and what functions, features, modules, and other elements of RMP 302 to invoke. For example, if a request is received and parsed by API I/F module 334 and request handler/parser 304, respectively, to make a reservation at a restaurant, semi-automatically or automatically, a booking may be performed by RMP 302 by sending booking data, guest data, and payment data to RMP client application 216 (FIG. 2) using RMP client module 310, the latter of which is used to configure and manage RMP clients installed on various devices (e.g., clients 106, 110-112, 120-124 (FIG. 1).

Referring back to FIG. 3, if a request is received including data indicating cancellation of a reservation, the request is parsed by request handler/parser 304 to identify attributes and parameters associated with the reservation being cancelled. Logic/algorithmic/AI module 308 sends control data and signals to one or more of elements 306, 310-334 to initiate generation of an augmented request. Augmented request generator 306 may be used to create a ticket for the cancellation parameters and attributes, but also include other data based on rules (i.e., rules 326) applied to the received request. Examples of data in a generated augmented request for a ticket may include profile data 312 (e.g., user profile, name, preferences, reservation history, notes, PPA, and the like) as well as other data that may be assigned by, for example, reservation proxy server 330. Other examples of data generated for a ticket from a cancellation request and included in an augmented request may include pricing data generated by demand/dynamic pricing module 316. In some examples, pricing for a given reservation (in the context of a restaurant) may, in concert with logic/algorithmic/AI module 308, invoke demand-based pricing that is dynamically adjusted for dates, times, party sizes, or other parameters or rules established by a restaurant or environmental factors (e.g., holidays, closures, staffing, or others, without limitation or restriction). Demand-based pricing module 316 may be a process, algorithm, application, component, or service used to provide pricing functionality when generating an augmented request for a ticket based on a cancelled reservation.

In some examples, reservation proxy server 330 may be configured to intercept a cancellation request being sent to a restaurant. RMP 302 intercepts or receives via RMP client application 216 (FIG. 2) a copy of the request cancelling a reservation and logic/algorithmic/AI module 308 sends control data and signals to reservation proxy server 330 and augmented request generator to generate a ticket embodied in an augmented request, including a reservation identifier (i.e., Reservation Identifier or ResID, as used interchangeably herein). Further, augmented request generator 306 and reservation proxy server 330 may be invoked to generate and include other information in an augmented request, such as anonymized information to prevent disclosure of personal information such as a person's specific name, contact information (e.g., home address, phone number, cell phone number, work address, social security information, photos, and the like, without limitation or restriction), financial information (e.g., payment information, bank account or credit card account information used to pay for tickets or reserved dining sessions), guest names, information of other party members, and the like. Reservation proxy server 330, in other examples, may also be configured to map data in an augmented request to a unique reservation identifier (i.e., ResID) assigned to a ticket and store the mapping data, metadata, schema, or other data structures in proxy data 328. In some examples, a reservation identifier or ResID may be a unique identifier that RMP 302 generates and assigns to a ticket in order to anonymize, protect, encrypt, or otherwise shield personal or sensitive information from being transmitted. ResIDs may be received, analyzed, and interpreted by RMP 302 or RMP client application 216 (FIG. 2) used by, in some examples, a restaurant. When a lookup is performed, in some examples, a ResID may be used to reference data stored in proxy data 328. In other examples, secure technology such as blockchain encryption (hereafter “blockchain”) may also be used to protect data stored in proxy data 328 by creating non-fungible tokens (i.e., “NFTs”) that may be referenced, queried, and/or retrieved when mapped to a given ResID.

In some examples, data input received from RMP client application 216 may be transmitted back to RMP 302 indicating whether a restaurant has selected a given ticket (i.e., the ResID) and, if so, identifying information for the ticketed event may be entered and confirmed with the diner identified in the ticket (i.e., augmented request) by the anonymizing ResID. In other examples, a user of RMP client application 216 (FIG. 2) may also book and confirm a reservation indicated by a ticket transmitted as an augmented request from RMP 302 to RMP client application 216.

In some examples, by applying business rules (i.e., rules) using rules module 324 and retrieving rules from rules data 326, augmented requests may be generated in a custom manner for individual organizations. For example, some organizations may require particular data integration with CRM systems for use in other programs, applications, services, or platforms, thus invoking CRM module 318 to process, parse, and format data such as augmented requests for ingestion or querying/retrieval from CRM system 238 (FIG. 2) or the like. In other examples, organizations (e.g., restaurants, hotels, airlines, travel companies, transportation companies, freight forwarding companies, vehicle/vessel rental companies, and others, without limitation or restriction) may input, via RMP client module 310, rules that are processed by rules module 324 and stored in rules data 326 and used to publish, distribute, display, or otherwise present tickets on one or more marketplaces, open or closed, including those hosted and run by RMP 302 using marketplace integration module 314.

In some examples, marketplaces may be generated, accessed, managed, or otherwise used to publish tickets for sale. RMP 302 may be configured to invoke marketplace integration module 314 to integrate with an open marketplace (i.e., an online marketplace generated, hosted, served, or otherwise instantiated using RMP 302) or a closed marketplace (i.e., a closed marketplace used by a restaurant or other organization for reservation scheduling and management, but without features or functionality to view, accept, or decline tickets generated as augmented requests from RMP 302 such as those mentioned above). Limitations of closed marketplaces prevent wider dissemination of tickets to increase financial activity, for example, by a restaurant, but using RMP 302 to generate, host, serve, and instantiate a marketplace over one or more data networks as well as being coupled in data communication with closed marketplaces may create marketplaces for tickets to be purchased, sold, distributed, published, or otherwise commercialized, creating additional opportunities to avoid revenue shortfalls caused by unsold inventory (i.e., cancelled reservations that are eventually neither filled nor used, whether by a restaurant, hotel, airline, rental agency, or others, without limitation or restriction). Further examples of functionality that may be enabled by RMP 302 include the integration of data when generating an augmented request to target electronic delivery of a ticket to a particular role within an enterprise. For example, an augmented request may include monetary or financial incentives to include in a ticket generated from an augmented request sent to RMP client application 216 (FIG. 2) hosted on a tablet computer (not shown) being used by a maître d'hotel. Using data from role management module 322, RMP 302, logic/algorithmic/AI module 308, and augmented request generator 306, a ticket may be generated from an augmented request and, when received by a recipient (e.g., the maître d'hotel reviewing received messages from RMP 302 presenting offered tickets or reviewing a marketplace generated by marketplace integration module 314 or a closed marketplace used by the restaurant but integrated (using marketplace integration module 314) with RMP 302, presents a ticket that, if accepted, results in a booking (i.e., reservation) for a party of committed size, time, duration, PPA (i.e., the estimated revenue to be generated from the reservation on a per person average amount) as well as a transaction in which an additional incentive is paid by a diner (i.e., the person making the reservation ultimately) as either an incentive to accept the ticket and/or an additional gratuity (i.e., tip) for service provided during the reservation. Alternatively, a diner may be reviewing RMP client application 216 (FIG. 2) on a smartphone or other mobile device (not shown) to view tickets available for purchase of a restaurant reservation and, upon selecting the ticket say, through an interactive widget (e.g., button, selection window, pull down menu, or others, without limitation or restriction) on an interface presented by RMP client application 216 (FIG. 2), she may be able to purchase, reserve, and pay for the booking. No further financial transaction handling, including at the site of the reservation, needs to be performed as payment for the reservation is made using an integrated POS system that is called, managed, hosted, or otherwise accessed by RMP 302 using POS module 338.

Still further, CRM module 318 may be configured to integrate other systems (e.g., payment, financial, credit, or others, without limitation or restriction) with RMP 302, RMP client application 216 (FIG. 2), and marketplace (closed) 226 (FIG. 2). As used herein, marketplace (closed) 226 (FIG. 2) and RMP client application 216 (FIG. 2) may be configured to be implemented and used by an intended recipient, customer, or user of RMP 302 such as a restaurant, hotel, travel or transportation company, vehicle/vessel rental company, and others, without limitation or restriction. In other examples, arrangement, size, position, quantity, function, structure, process, and/or configuration of the elements shown may be varied and are not limited merely to or by any specific description or feature shown and/or described in this Detailed Description.

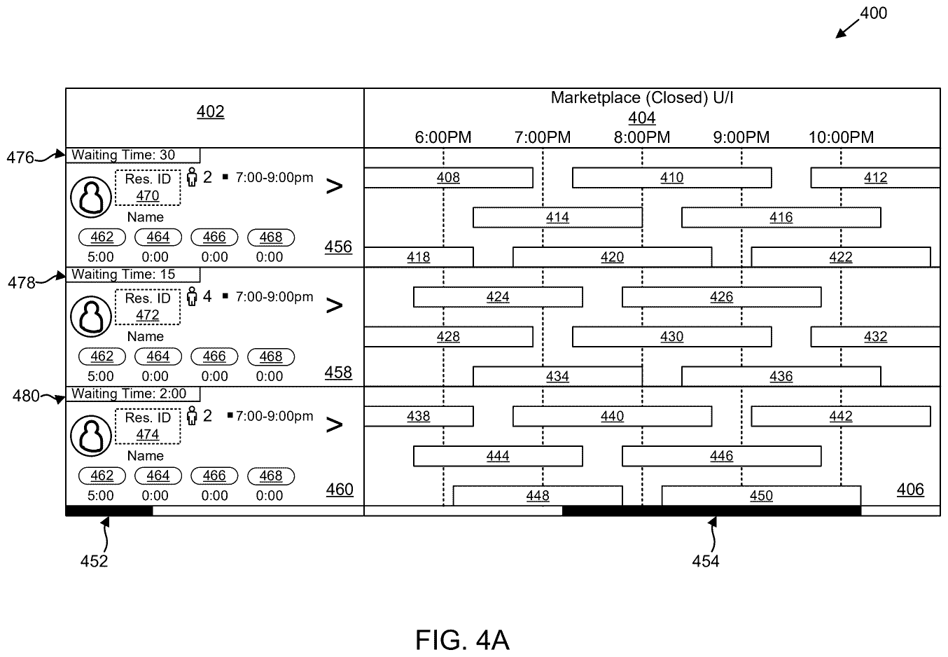

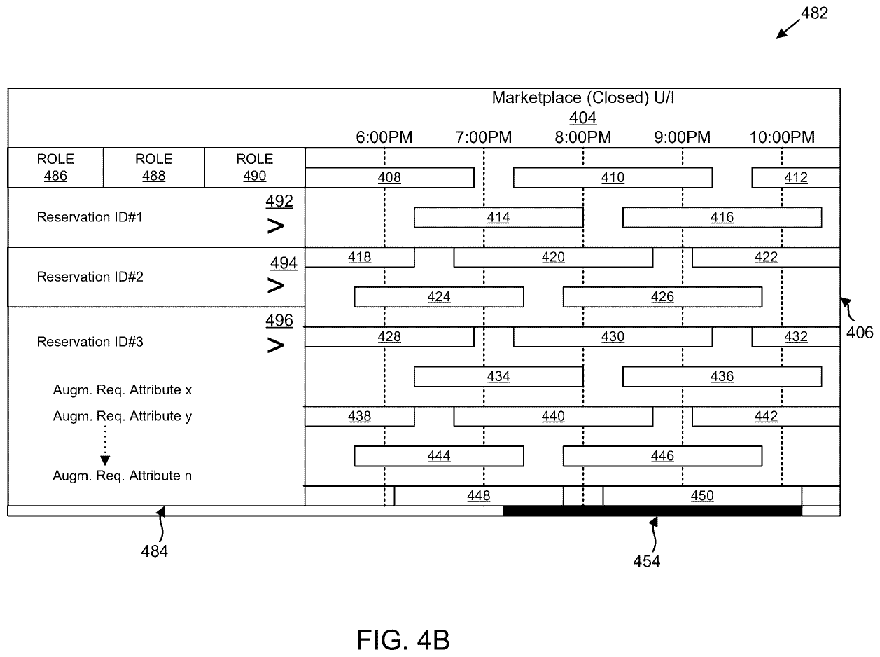

FIG. 4A illustrates an exemplary user interface for reservation management using distributed computing networks. Here, exemplary user interface 400 (hereafter “interface 400”) includes panels 402-404, reservation schedule 406, reservation windows 408-450, slider bars 452-454, tickets 456-460, icons 462-468, ResIDs 470-474, and information windows 476-480. Here, interface 400 may be presented as a display, user interface (“UI”), user experience (“UX”), or the like served by RMP client application 216 (FIG. 2), RMP application server 204 (FIG. 2), and/or RMP 302 (FIG. 3). When presented, panel 402 may be generated by RMP 302 (FIG. 3) and presented to show available reservations in tickets 456-460 as identified by ResIDs 470-474. In some examples, panel 404 may also be presented to show reservations that have been booked (i.e., tickets) and time periods for which the reservations are made and time periods allocated (i.e., reservation windows 408-450). In other examples panel 404 may be a panel viewed by either a prospective diner, traveler, or reservation purchaser as well as a receiving enterprise, organization, company, restaurant, agency, or other entity that is accepting tickets to fulfill, displaying reservation windows. One, both, or either of panels 402-404 may be presented for display on a client device (i.e., by using RMP application 204 serving RMP client application 216), but in some examples, panels may be suppressed or selectively shown, displayed, published, or otherwise presented on client devices (e.g., clients 106, 110-112, 120-124 (FIG. 1), or others, without limitation or restriction) based on the type of user or role (as determined by role management 322 (FIG. 3).

Referring back to FIG. 4A, various types of information may be presented in connection with panel 402, reservations displayed in tickets 456-460. In some examples, icons 462-468 may be presented to show a status of each of tickets 456-460. For example, icons 462-468 may display various types of status such as “Working,” “Reservation Proposed,” “Reservation Made,” “Confirmed,” or others, without limitation or restriction. Other information such as the starting time and expected duration of a reservation (e.g., “7:00-9:00pm”), name of the diner, user, or guest associated with the reservation may be displayed. ResIDs 470-474 may also display a unique identifier generated and assigned to each ticket by RMP 302 (i.e., augmented request generator 306 (FIG. 3)). Using a ResID (e.g., ResIDs 470-474), tickets 456-460 may be uniquely identified by RMP client application 216 (FIG. 2) and, if accepted, can be used to create a reservation window (e.g., reservation windows 408-450. In other examples, if a diner (i.e., user, purchaser, or the like) sells a ticket, ResIDs 470-474 may be used to identify details associated with a given reservation on a marketplace (not shown), which may be an open marketplace and/or a closed marketplace. Further, ResIDs 470-474 provide a mapping of guest profile data 208 (FIG. 2) to reservation data 210 (FIG. 2) that may be used to look up reservation details that can be shared between RMP 302 and a RMP client application (e.g., RMP client application 216 (FIG. 2)). In other examples, arrangement, size, position, quantity, function, structure, process, and/or configuration of the elements shown may be varied and are not limited merely to or by any specific description or feature shown or described in this Detailed Description.

FIG. 4B illustrates an exemplary user interface for reservation management using distributed computing networks. Here, exemplary user interface 482 (hereafter “interface 482”) includes an alternate view of panel 404, reservation schedule 406, reservation windows 408-450, slider bar 454, pop-up window 484, role tabs 486-490, and reservation subpanels 492-496. In some examples, interface 482 may be generated by RMP 302 (FIG. 3), RMP application server 204 (FIG. 2), and RMP client application 216 (FIG. 2) to be presented or displayed on the latter, including elements that may be similar to those described and like numbered in the preceding FIG. 4A. Here, an alternate interface (i.e., interface 482) may be invoked by a user, diner, host, hostess, maître d'hotel, or other role using, for example, RMP client application 216 (FIG. 2). When invoked, pop up window 484 may be displayed or superimposed over reservation schedule 406, presenting information on various tickets (i.e., reservations) made available for purchase, booking, confirmation, selection, or other operations.

In some examples, information displayed in pop up window 484 may include a reservation ID and one or more attributes associated with a given ticket, as extracted from an augmented request generated by RMP 302 (FIG. 3), as described above. Here, attributes x-n may be displayed in connection with a given ticket (i.e., reservation subpanel 496) and varied, without limitation or restriction as to quantity, type, or type of data represented). Augmented request attributes (i.e., attributes associated with, included, or parsed from a ticket represented by an augmented request generated from a reservation cancellation) may include various types of data and information including reservation start time, reservation duration, party size, name of diner making a reservation, diner or user preferences (e.g., seating preferences, table preferences, service preferences, waitstaff preferences, and others, without limitation or restriction), historical PPA for a restaurant or category of restaurants, gratuity amount, incentive amount (i.e., for accepting a given ticket as determined from parsed data of an augmented request), and other data and information, without limitation or restriction.

As shown, reservation subpanels 492-496 may be selected to invoke or display information superimposed in another popup window (not shown) over reservation schedule 406. Information that may be included in a pop up window that is selected for expansion (e.g., by selecting the “>” shown in each of reservation subpanels 492-496) may include information, data, or attributes for consideration when a user is determining whether to accept or purchase a given ticket. Once accepted (i.e., purchased by a diner, confirmed by a restaurant employee, contractor, such as a host, hostess, or maître d'hotel), then the selected ticket, based on its reservation ID, may be retrieved from proxy data 328 (FIG. 3) and integrated with reservation schedule 406 by creating a reservation window or selecting one of reservation windows 408-450. In other examples, selecting a reservation subpanel (e.g., reservation subpanels 492-496) may also call or instantiate another pop up window (not shown) that displays other information, data, or attributes associated with a given ticket (e.g., as displayed in reservation subpanels 492-496). Views in pop up window 484 may be changed or varied as role tabs 486-490 are selected using a human-computer interface (hereafter “HCI”) such as trackpad, mouse pad, mouse, joystick, or other HCI device. Selecting one of role tabs 486-490 may be used to change reservation subpanels 492-496 or display information that replaces reservation subpanels 492-496. For example, role tab 486 may be a tab for a given user or diner. When selected, a history of reservations made by the user or diner may be presented in each of reservation subpanels 492-496 and, in the event of a lengthy reservation history, a vertical slide bar (not shown) may be integrated with pop up window 482. In other examples, one or more of role tabs 486-492 may be associated with individual employees, contractors, owners, or other stakeholders at a given organization (e.g., restaurant, hotel, airline, or others, as described above). When selected, one or more of role tabs 486-492 may be configured to invoke or call another routine, program, or application that displays different data in reservation subpanels 492-496, such as prospective reservations that may be selected based on availability, incentive amounts, estimated PPA, or other attributes (e.g., attributes x-n, as displayed in reservation subpanel 496, for example). The type of information and data displayed in association with different roles may be varied, without limitation or restriction. In still other examples, arrangement, size, position, quantity, function, structure, process, and/or configuration of the elements shown may be varied and are not limited merely to or by any specific description or feature shown or described in this Detailed Description.

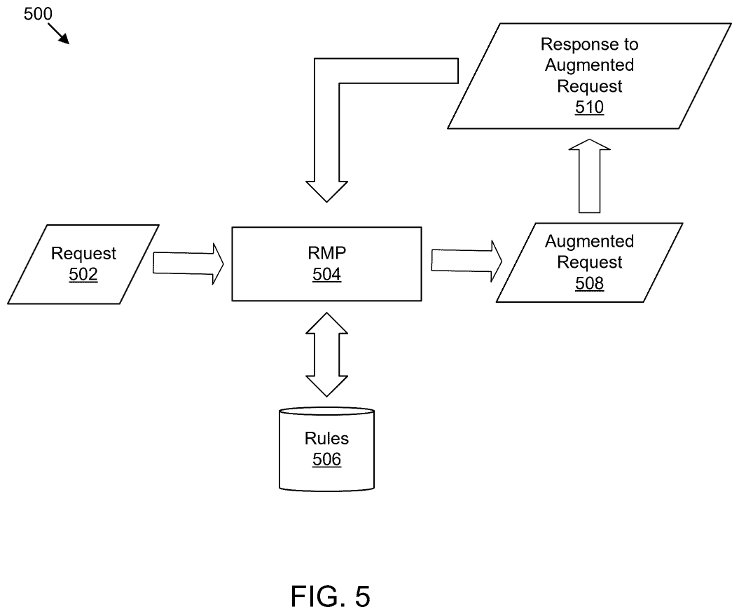

FIG. 5 illustrates an exemplary data flow diagram for reservation management using distributed computing networks. Here, exemplary data flow diagram 500 (hereafter “data flow 500”) illustrates the typical data flow when a cancellation request is received by RMP 202 (FIG. 2) by RMP client application 216 (FIG. 2) or RMP 302 (FIG. 3). As shown, request 502 is sent to and received by RMP 504 (which may be implemented using one, some, all, or none of RMP 102 (FIG. 1), RMP 202 (FIG. 2), RMP client application 216 (FIG. 2), and/or RMP 302 (FIG. 3)). During processing by RMP 504, rules 506 (e.g., business rules established, input, or otherwise configured by a business, restaurant, hotel, airline, vehicle/vessel rental agency, or others, without limitation or restriction) are retrieved in response to one or more queries generated by RMP 504 of rules stored in data repositories such as rules data repository 118 (FIG. 1), rules data repository 212 (FIG. 2), and/or rules data repository 326 (FIG. 3). As described in this Detailed Description, rules 506 are used to process a request (i.e., a cancellation request) from a user (e.g., diner, guest, or others), including information and/or data such as attributes associated with the conversion of the cancelled reservation into a ticket generated by RMP 504 and sold on, for example, marketplace (closed) 226 (FIG. 2) and/or a marketplace rendered and served by RMP marketplace module 206 (FIG. 2).

Referring back to FIG. 5, RMP 504, in some examples, receives request 502, processes request 502 in accordance with rules 506, and generates augmented request 508. Augmented request 508 is then transmitted, in some examples, from RMP 202 (FIG. 2) to RMP client application 216 (FIG. 2) for display and rendering on a client application user interface such as those shown and described in connection with FIGS. 4A-4B. As shown and described, various types of interfaces such as interface 400 (FIG. 4A) and interface 482 (FIG. 4B) may be generated and rendered by data produced by RMP application server 204 (FIG. 2) and rendered or displayed on a client device, such as those described above (e.g., clients 106, 110-112, or 120-124 (FIG. 1), or others, without limitation or restriction to the examples shown and described, which are provided for illustrative purposes).

In some examples, once an augmented request is received, parsed, and processed by RMP client application 216 (FIG. 2) on a client device(s) (e.g., clients 106, 110-112, or 120-124 (FIG. 1), or others, without limitation or restriction), an interactive graphical or non-graphical element (not shown) may be rendered on a display on which information and data such as augmented attributes are presented. Upon selection of a ticket associated with a given augmented request, data representing a responsive input (510) is transmitted back to RMP 504. In other examples, data flow 500 may be varied in arrangement, function, process, and/or configuration and is not limited merely to or by any specific description or feature shown or described in this Detailed Description.

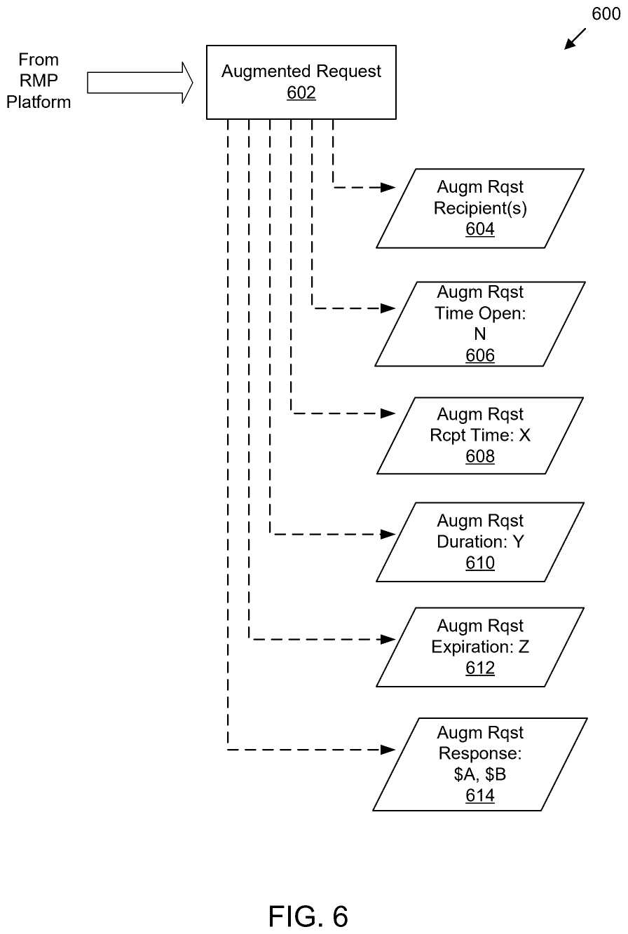

FIG. 6 illustrates an exemplary augmented request used in reservation management using distributed computing networks. Here, augmented request 600 is shown including various types of attributes 604-614. The number, type, context, and content of attributes 604-614 may be varied and is not limited to the specific examples shown and described. Examples of attributes that may be included in augmented request 602 may include, but is not limited to, augmented request recipient(s) attribute 604, augmented request time open attribute 606, augmented request receipt time attribute 608, augmented request duration attribute 610, augmented request expiration attribute 612, and augmented request response cost attribute 614. The data attribute types 604-614 may be varied and are not limited to the examples shown and described.

Here, RMP (e.g., RMP 102 (FIG. 1), RMP 202 (FIG. 2), RMP 302 (FIG. 3), and the like, without limitation or restriction) generates augmented request 602 to include various types of information, data, and attributes such as attributes 604-614. In some examples, augmented request 602 may be a data structure that includes data representative or indicative of a ticket that is generated from a request to cancel a reservation. Rather than merely cancel a reservation and reopen a time window for reservation availability (which often fails to lead to a conversion to a ticket (i.e., a reservation leading to a revenue or income generating event (e.g., an actual paid meal, flight, purchase, rental, or the like), augmented request 602 may be configured for many other types of functions, features, and operations beyond merely recycling availability of a reservation. Attributes included or integrated within the data structure and schema of augmented request 602 may include various types of data and information. For example, augmented request recipient(s) attribute 604 may be implemented as data that indicates an intended recipient such as a particular restaurant, hotel, airline, company, or other organization or entity at which a reservation is desired. As another example, augmented request time open attribute 606 may indicate a start time for a given reservation. Yet another example is augmented request receipt time attribute 608, which may be configured to indicate a time of receipt for augmented request 602 and which may be used to indicate the start of a finite period of time during which a given ticket remains available. As an example, a prospective diner may purchase or bid on a ticket associated with augmented request 602 and augmented request receipt time attribute 608 may indicate the start time for a 2 hour time period during which the ticket remains available for a restaurant to accept, book, and confirm a reservation. Conversely, augmented request receipt time attribute 608 may also indicate a start time indicated by a restaurant for purchasing a ticket to a given restaurant, after which the reservation associated with the ticket indicated by augmented request 602 is withdrawn, cancelled, rescinded, or otherwise modified.

As yet another example, augmented request duration attribute 610 may be included with augmented request 602 to indicate the time period (i.e., reservation window) of a ticket (i.e., offered reservation indicated by augmented request 602). Still further, augmented request expiration attribute 612 may indicate the expiration of a given ticket or reservation indicated by augmented request 602. In other words, a given ticket may expire at the end of a particular time period, date, or other specified period during which the ticket indicated by augmented request 602 remains open. Once past, a ticket indicated by augmented request 602 may expire. In some examples, augmented request expiration attribute 612 may be a period of time after which a given ticket increases (or decreases) in value or price. In other examples, augmented request expiration attribute 612 may also indicate a period of time after which a promotion, incentive, gratuity, price, value, discount, or other aspect of a given ticket expires and becomes no longer available to a purchaser, bidder, or other entity or organization capable of accepting the ticket and booking/confirming a reservation associated with the ticket indicated by augmented request 602. In yet a further example, augmented request response attribute 614 may indicate one or more data attributes indicative of a cost or price associated with a ticket, which may establish a threshold for accepting (or rejecting) the ticket. In yet other examples, augmented request 602 and attributes 604-614 may be varied and are not limited merely to or by any specific description or feature shown or described in this Detailed Description.

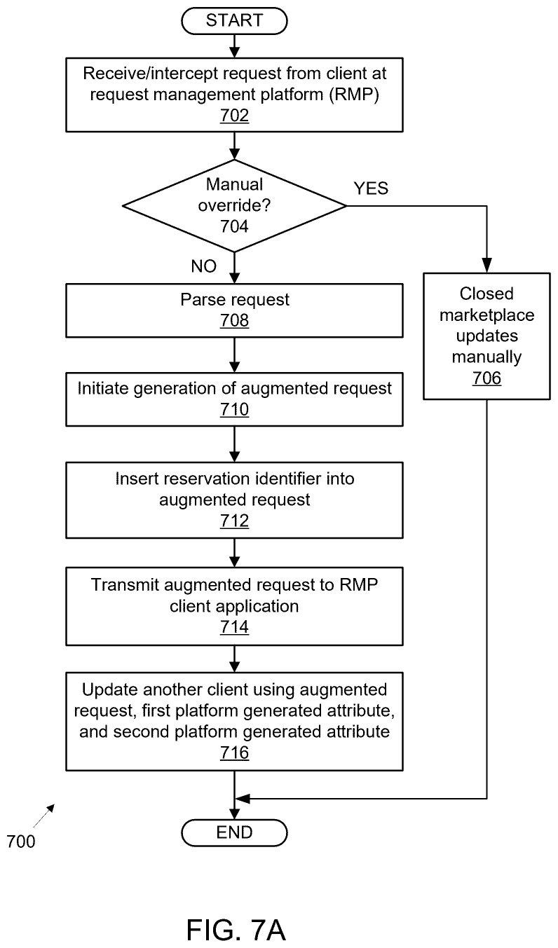

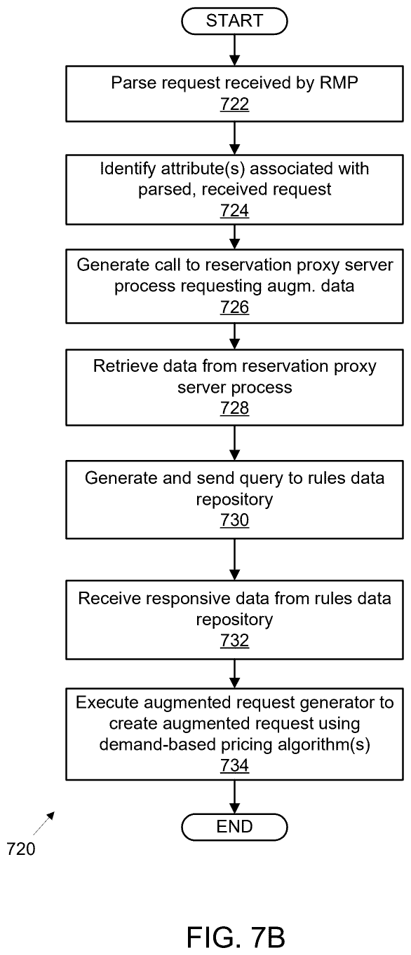

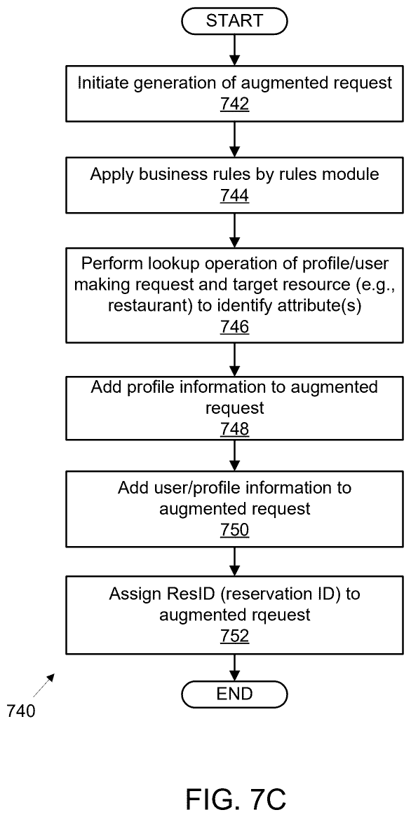

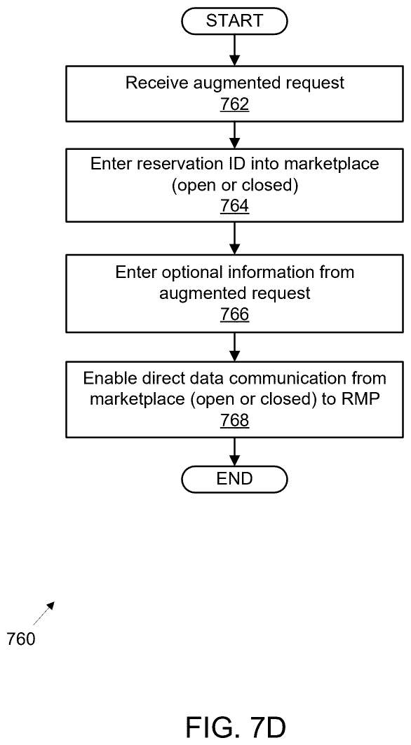

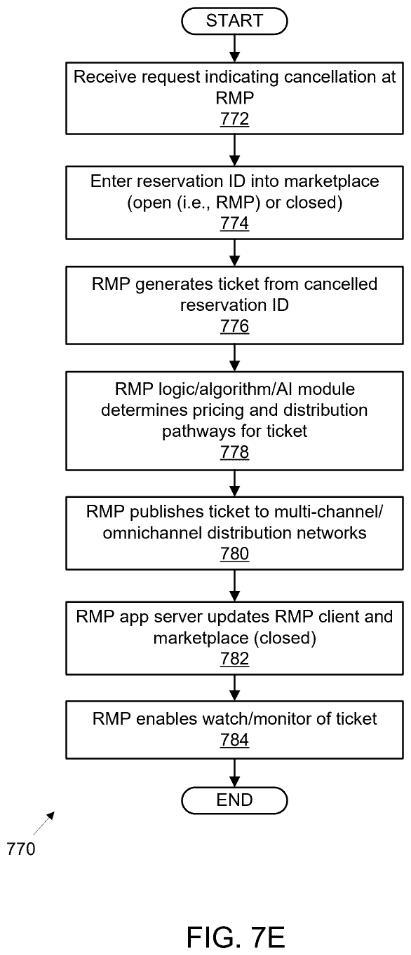

FIG. 7A illustrates an exemplary process for reservation management using distributed computing networks. Here, exemplary process 700 (hereafter “process 700”) starts when a request from a client (i.e., RMP client application 216 (FIG. 2)) at a RMP (e.g., RMP 102 (FIG. 1), RMP 202 (FIG. 2), RMP 302 (FIG. 3), or the like) (702). A determination is made as to whether the request indicates a reservation that may be manually accepted (704). If accepted manually, a reservation may be accepted, booked, and confirmed manually using a RMP client using, in some examples, RMP client application 216 (FIG. 2) or a marketplace (e.g., open marketplace (i.e., generated, served, and rendered by RMP 102 (FIG. 1), RMP 202 (FIG. 2), RMP 302 (FIG. 3), or the like and/or a closed marketplace, such as those described above (706). However, if a reservation indicated by a request is not accepted, booking, and confirmed manually, then processing by a RMP commences (e.g., using RMP 102 (FIG. 1), RMP 202 (FIG. 2), RMP 302 (FIG. 3), or the like).

In some examples, a RMP parses a request received (708) then initiates the generation of an augmented request if the request indicates the cancellation of a reservation (710). During the generation of an augmented request (i.e., converting a cancelled reservation into a ticket or ticketed reservation, used interchangeably herein), a reservation identifier is generated, assigned, and inserted into a ticket by, for example, augmented request generator 306 (FIG. 3) (712). After generation by a RMP, a ticket is transmitted to one or more RMP client applications (e.g., RMP client application 216 (FIG. 2), or the like, without limitation or restriction)) used to manage reservation bookings, including those sent directly as requests or tickets or indirectly, as those accepted or otherwise retrieved from a marketplace (i.e., open or closed, as described above) (714). Once transmitted, a RMP client application may be updated using information, data, and attributes contained or included within the augmented request (716).

In other examples, a received request may be a cancellation request (i.e., a request to cancel a reservation) previously made using an online reservation system, such as those described above. In response to a received cancellation request, processing may be performed including automatically (or semi-automatically, manually, or the like) querying a data repository storing a business rule or set of business rules that are user or system-specified. In some examples, user or system-specified rules may be determined manually, semi-automatically, automatically, or through the use of AI. In yet other examples, rules may also be determined by a user or operator of an online reservation system while still other rules may be determined by a user or operator of a restaurant, airline, vehicle or vessel rental agency, or other user of RMP 102 (FIG. 1), RMP 202 (FIG. 2), or RMP 302 (FIG. 3), including, but not limited to, a closed marketplace (e.g., marketplace (closed) 226 (FIG. 2)). Once retrieved, business rules may be used, referenced, or otherwise applied to determine how RMP 202 should process a cancellation request. Further, during the processing and application of rules (e.g., business rules) to a cancellation request, attributes parsed from the cancellation request upon its receipt may also be used to process said cancellation request in order to generate an augmented request, such as a ticket that may be later purchased, sold, published, advertised, or otherwise made publicly available for purchase or reservation by either the original RMP client that initiated the cancellation request or another party (i.e., another RMP client) that may be interested in purchasing or otherwise accepting the ticket (i.e., augmented request) generated from the cancellation request.

As an example, rules may also be used to determine how to process, once generated, a cancellation request for rerouting. For example, a cancellation request may be rerouted through a reservation marketplace (e.g., RMP 102 (FIG. 1), RMP 202 (FIG. 2), or RMP 302 (FIG. 3)), saving to a data repository (e.g., reservation data 210 (FIG. 2)), or instead transmitting an augmented request associated with the requested cancellation to one or more specific RMP clients (e.g., other users, diners, or the like), who may be identified based on parsing attributes from the cancellation request upon receipt by, for example, RMP 102 (FIG. 1), RMP 202 (FIG. 2), or RMP 302 (FIG. 3), or based on business rules (e.g., rules 212 (FIG. 2)) that may be established and queried/retrieved during processing of a cancellation request.

In other examples, the above-described process may be varied in order, function, and/or structure, and is neither restricted nor limited to any particular exemplary process shown or described in the accompanying drawings or this Detailed Description.

FIG. 7B illustrates an exemplary process for generating an augmented request using techniques for reservation management using distributing computing networks. Here, process 720 starts when a request received by RMP 102 (FIG. 1), RMP 202 (FIG. 2), or RMP 302 (FIG. 3) is parsed (722). As a result of parsing, analysis is performed to identify one or more attributes associated with the incoming request (724). Once identified, a call is performed to reservation proxy server 330 (FIG. 3) to generate an augmented request (726). In response to a call to reservation proxy server 330 (FIG. 3), responsive data is retrieved (728). Using the data retrieved from reservation proxy server 330 (FIG. 3), a query is generated and transmitted via data bus 336 (FIG. 3) to rules data repository 326 (FIG. 3) to retrieve rules and data to apply during the augmented request generation process (730). In response to the query of rules data repository 326 (FIG. 3), responsive data is received, providing rules to be applied to the process of generating an augmented request (732). Finally, augmented request generator finalizes generation of an augmented request (which is described in greater detail below in connection with FIG. 7C) and determines/assigns pricing to the generated augmented request prior to transmission to RMP client application 216 (FIG. 2) (734). In other examples, the above-described process may be varied in order, function, and/or structure, and is neither restricted nor limited to any particular exemplary process shown or described in the accompanying drawings or this Detailed Description.

FIG. 7C illustrates an exemplary process for using an augmented request in reservation management using distributed computing networks. Here, process 740 starts by initiating generation of an augmented request (742). Rules (e.g., business rules) are then applied by rules module 324 (FIG. 3) to determine what attributes to include within an augmented request being generated by, for example, augmented request generator 306 (FIG. 3) (744). In some examples, lookup operations, queries, and retrieval operations of profile/user data (e.g., from profile data repository 312 (FIG. 3)) may be performed to identify attribute(s) to be included in an augmented request (746). Further, attributes identifying a target resource (e.g., restaurant, hotel, airline, vehicle/vessel rental agency, or other companies or organizations intending to receive requests and augmented requests) may also be identified for inclusion in an augmented request. After identifying attributes to include in an augmented request, these are included along with profile/user data during the generation process by, for example, augmented request generator 306 (FIG. 3) (748-750). After including identified attributes in an augmented request to be used to generate a ticket from a cancelled reservation, a reservation identifier is system-generated by RMP 102 (FIG. 1), RMP 202 (FIG. 2), or RMP 302 (FIG. 3) by, in some examples, augmented request generator 306 (752). In other examples, the above-described process may be varied in order, function, and/or structure, and is neither restricted nor limited to any particular exemplary process shown or described in the accompanying drawings or this Detailed Description.

FIG. 7D illustrates an exemplary process for augmented request handling in reservation management using distributed computing networks. Here, process 760 starts when an augmented request is received by, for example, RMP client application 216 (FIG. 2), which may be integrated with marketplace (closed) 226 (FIG. 2) or as a standalone reservation management system placed in use for a restaurant, hotel, airline, travel company, vehicle/vessel rental agency, or the like (762). Upon receipt by RMP client application 216 (FIG. 2), a reservation identifier (i.e., ResID) is retrieved from the received augmented request and used for reference by a marketplace, such as those described above (764). Attributes and other information included in an augmented request may also be entered into RMP client application 216 (FIG. 2) and/or marketplace(s), open or closed (766). Finally, once active in a marketplace (open or closed), a ticket associated with the received augmented request may be enabled for various types of data operations (e.g., bidding, purchasing, selling, counter offering, or others, without limitation or restriction). In other examples, the above-described process may be varied in order, function, and/or structure, and is neither restricted nor limited to any particular exemplary process shown or described in the accompanying drawings or this Detailed Description.

FIG. 7E illustrates an exemplary process for handling a cancellation request in reservation management using distributed computing networks. Here, process 770 starts when a request is received by RMP 102 (FIG. 1), RMP 202 (FIG. 2), or RMP 302 (FIG. 3) to cancel a reservation (772). Using a reservation identifier (i.e., ResID) parsed and extracted from the cancellation request (i.e., request), a lookup operation may be performed of a marketplace (open and/or closed) to identify the reservation subject to the request (774). Once identified, RMP 102 (FIG. 1), RMP 202 (FIG. 2), or RMP 302 (FIG. 3) creates a ticket that is associated with an augmented request that is generated (i.e., by augmented request generator 306 (FIG. 3)) (776).

In some examples, RMP 302 (FIG. 3) then invokes RMP logic/algorithmic/AI module 308 (FIG. 3) and demand/dynamic pricing module 316 (FIG. 3) to generate and assign a price to the ticket being generated from a cancelled reservation and to identify distribution pathways for an augmented request generated from the cancellation (778). As an example, distribution pathways may refer to any identified marketplace, auction website, online or electronic listing of tickets generated from cancelled reservations using the techniques described in this Detailed Description (778). After generating an augmented request identified with a ticket created from a cancelled reservation, RMP 102 (FIG. 1), RMP 202 (FIG. 2), or RMP 302 (FIG. 3) transmits the augmented request and publishes the ticket using various types of social media channels, networks, websites, and other online destinations over data, video, voice, multi-media, or other “omnichannel” distribution networks (780). After transmission of an augmented request to identified destinations using omnichannel distribution networks, RMP application server 204 (FIG. 2) updates RMP client application 216 (FIG. 2) and any marketplaces on which a ticket associated with the received augmented request is published, displayed, rendered, or otherwise listed (782). Upon posting to a marketplace and updates are completed to RMP client application 216 (FIG. 2) upon receipt of an augmented request, RMP 102 (FIG. 1), RMP 202 (FIG. 2), or RMP 302 (FIG. 3) enable electronic monitoring of the reservation identifier (i.e., ResID) for changes or the receipt of data in response to the posting of the ticket (784). In other examples, the above-described process may be varied in order, function, and/or structure, and is neither restricted nor limited to any particular exemplary process shown or described in the accompanying drawings or this Detailed Description.

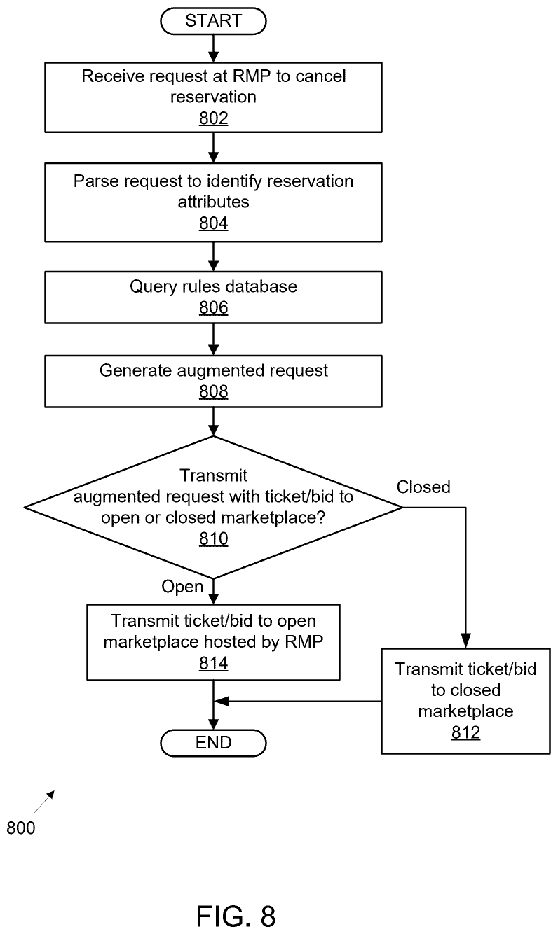

FIG. 8 illustrates an alternative exemplary process for reservation management using distributed computing networks. Here, alternative exemplary process 800 (hereafter “process 800”) starts when RMP 102 (FIG. 1), RMP 202 (FIG. 2), or RMP 302 (FIG. 3) receives an electronic data request (i.e., request) over a data network to cancel a reservation (802). As an example, the request is parsed to identify one or more attributes associated with the request (804). Using identified attributes, parameters, or other data included in the received request, rules data repository 212 (FIG. 2) is queried (806). In some examples, after retrieving responsive data in response to a query of rules data repository 212 (FIG. 2), generation of an augmented request is performed (808).

In some examples, after generating an augmented request in response to a request to cancel a reservation, a ticket is created, including any information, data, or attributes associated with a reservation to be associated with the ticket. Once generated, a determination is made as to whether an augmented request associated with a ticket for a reservation is to be transmitted (i.e., over one or more data networks) to 1) an open marketplace (i.e., a marketplace generated, rendered, operated, and monitored by RMP 102 (FIG. 1), RMP 202 (FIG. 2), or RMP 302 (FIG. 3), which may be configured for data communication with other marketplaces, regardless of whether open or closed, or 2) a closed marketplace (e.g., marketplace (closed) 226) provided by a third party software developer and which is not configured for open data communication with other platforms. Using RMP client application 216 (FIG. 2), RMP application server 204 (FIG. 2), and other functionality served by RMP 102 (FIG. 1), RMP 202 (FIG. 2), or RMP 302 (FIG. 3), closed marketplaces (e.g., marketplace (closed) 226) may be networked to share data such as augmented requests for distributing, publishing, sharing, or other arrangements in which tickets may be distributed. If a determination is made for a closed marketplace(s), then a generated augmented request is transmitted to said closed marketplace (e.g., marketplace (closed) 226 (FIG. 2)) (812). If a determination is made to publish a ticket to an open marketplace, then the associated augmented request generated in response to a cancellation request is transmitted to the open marketplace (814). In other examples, the above-described process may be varied in order, function, and/or structure, and is neither restricted nor limited to any particular exemplary process shown or described in the accompanying drawings or this Detailed Description.

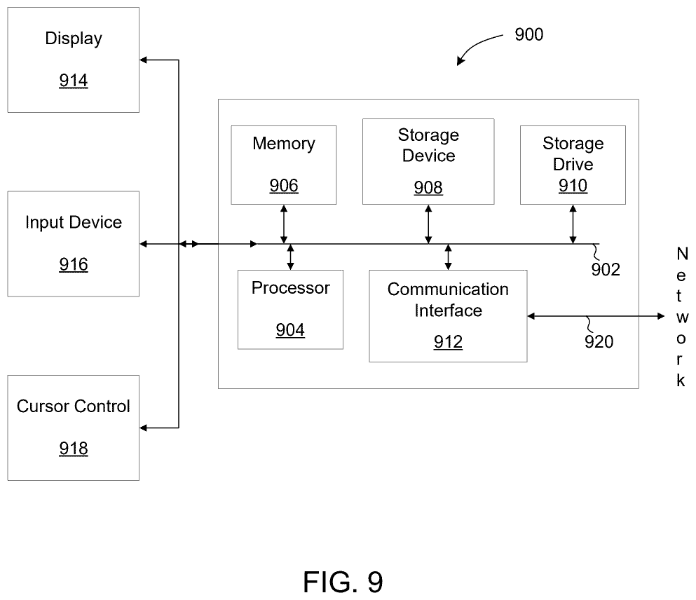

FIG. 9 illustrates an exemplary computer system suitable for reservation management using distributed computing networks. In some examples, computer system 900 may be used to implement computer programs, applications, methods, processes, or other software stored on or executed from a non-transitory medium to perform the above-described techniques. Computer system 900 includes a bus 902 or other communication mechanism for communicating information, which interconnects subsystems and devices, such as processor 904, system memory 906 (e.g., RAM), storage device 908 (e.g., ROM), storage drive 910 (e.g., magnetic, optical, quantum, or others, without limitation or restriction), communication interface 912 (e.g., modem or Ethernet card), display 914 (e.g., CRT or LCD), input device 916 (e.g., keyboard), and cursor control 918 (e.g., mouse or trackball).

According to some examples, computer system 900 performs specific operations by processor 904 executing one or more sequences of one or more instructions stored in system memory 906. Such instructions may be read into system memory 906 from another computer readable medium, such as static storage device 908 or storage drive 910. In some examples, hard-wired circuitry may be used in place of or in combination with software instructions for implementation.

The term “computer readable medium” refers to any tangible medium that participates in providing instructions to processor 904 for execution. Such a medium may take many forms, including but not limited to, non-volatile media and volatile media. Non-volatile media includes, for example, optical or magnetic disks, such as storage drive 910. Volatile media includes dynamic memory, such as system memory 906.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read.

Instructions may further be transmitted or received using a transmission medium. The term “transmission medium” may include any tangible or intangible medium that is capable of storing, encoding or carrying instructions for execution by the machine, and includes digital or analog communications signals or other intangible medium to facilitate communication of such instructions. Transmission media includes coaxial cables, copper wire, and fiber optics, including wires that comprise bus 902 for transmitting a computer data signal.

In some examples, execution of the sequences of instructions may be performed by a single computer system 900. According to some examples, two or more computer systems 900 coupled by communication link 920 (e.g., LAN, PSTN, or wireless network) may perform the sequence of instructions in coordination with one another. Computer system 900 may transmit and receive messages, data, and instructions, including program, i.e., application code, through communication link 920 and communication interface 912. Received program code may be executed by processor 904 as it is received, and/or stored in storage drive 910, or other non-volatile storage for later execution.

Although the foregoing examples have been described in some detail for purposes of clarity of understanding, the invention is not limited to the details provided. There are many alternative ways of implementing the invention. The disclosed examples are illustrative and not restrictive.

What is claimed:

1. A method, comprising:
receiving a request at a platform, the request initiated at a client in data communication with the platform;
parsing the request to perform a query of a database in data communication with the platform;
generating an augmented request with responsive data retrieved from the database in response to the query;
inserting a reservation identifier into the augmented request, the augmented request including the reservation identifier, a first platform-generated attribute, and a second platform-generated attribute;
transmitting the augmented request to another client; and
using the augmented request, the first platform generated attribute, and the second platform generated attribute to update the another client.

2. The method of claim 1, further comprising receiving another request initiated by the client, the another request being configured to modify one or more attributes of the request.

3. The method of claim 1, further comprising generating an updated augmented request configured to modify one or more attributes of the request and the data associated with the request being stored on the database and transmitted to the platform and the another client in substantially real-time.

4. The method of claim 1, wherein the request is associated with an electronic reservation.

5. The method of claim 1, wherein the request is associated with cancelling an electronic reservation.

6. The method of claim 1, wherein the parsing the request to perform the query of the database includes retrieving one or more rules to be applied to the request.

7. The method of claim 1, wherein parsing the request to perform the query of the database includes applying one or more rules retrieved from the database, the one or more rules being applied during generation of the augmented request.

8. The method of claim 1, wherein parsing the request to perform the query of the database includes applying one or more rules retrieved from the database, the one or more rules being applied during generation of the augmented request before transmitting the augmented request.

9. The method of claim 1, wherein the another client is an open marketplace.

10. The method of claim 1, wherein the another client is a closed marketplace.

11. The method of claim 1, wherein the another client is the platform, the platform being configured to transmit the augmented request to at least the another client with the first platform generated attribute and the second platform generated attribute.

12. The method of claim 1, wherein the augmented request comprises a ticket, the ticket being configured to be submitted to a marketplace electronically instantiated by the platform and configured to be electronically accessible by the another client.

13. A system, comprising:
a database configured to store data associated with a client and a platform; and
a processor configured to receive a request at the platform, the request initiated at the client in data communication with the platform, to parse the request to perform a query of the database in data communication with the platform, to generate an augmented request with responsive data retrieved from the database in response to the query, to insert a reservation identifier into the augmented request, the augmented request including the reservation identifier, a first platform-generated attribute, and a second platform-generated attribute, to transmit the augmented request to another client, and to use the augmented request, the first platform generated attribute, and the second platform generated attribute to update the another client.

14. The system of claim 13, further comprising a reservation proxy server process configured to identify a cancellation request associated with the request when the request is parsed.

15. The system of claim 13, wherein the augmented request is a ticket generated using one or more rules retrieved in response to the query of the database.

16. The system of claim 13, wherein the augmented request is a ticket generated using one or more rules retrieved in response to the query of the database, the one or more rules including at least one business rule being applied to the request by the platform to generate the augmented request.

17. The system of claim 13, wherein the first platform generated attribute comprises a first value associated with a ticket generated when the augmented request is generated and the second platform generated attribute comprises a second value associated with an invitation to accept the augmented request.

18. The system of claim 13, wherein the first platform generated attribute is a price associated with the augmented request, the augmented request being a ticket generated from a cancellation of a reservation based on the data from the client, the data being associated with the request.

19. The system of claim 13, wherein the augmented request is a non-fungible token generated using a blockchain.

20. A non-transitory computer readable medium having one or more computer program instructions configured to perform a method, the method comprising:
receiving a request at a platform, the request initiated at a client in data communication with the platform;
parsing the request to perform a query of a database in data communication with the platform;
generating an augmented request with responsive data retrieved from the database in response to the query;
inserting a reservation identifier into the augmented request, the augmented request including the reservation identifier, a first platform-generated attribute, and a second platform-generated attribute;
transmitting the augmented request to another client; and
using the augmented request, the first platform generated attribute, and the second platform generated attribute to update the another client.
